(19) United States
(12) Patent Application Publication
(10) Pub. No.: US 2026/0336376 A1
(43) Pub. Date: Oct. 29, 2026

(54) SAFETY DEVICE FOR A BATTERY OF AN ELECTRIC OR HYBRID VEHICLE

(71) Applicant: AMPERE S.A.S., Boulogne Billancourt (FR)

(72) Inventors: Jean-Marc CHAFFANJON, Villiers-Saint-Frederic (FR); Jean-Marie SALONDY, Guyancourt (FR)

(73) Assignee: AMPERE S.A.S., Boulogne Billancourt (FR)

(21) Appl. No.: 19/139,674

(22) PCT Filed: Dec. 12, 2023
(86) PCT No.: PCT/EP2023/085413

§ 371 Date: Jun. 16, 2026

(30) Foreign Application Priority Data
Dec. 16, 2022 (FR) FR2213527

(51) Int. Cl. B60K 1/04; A62C 3/07; A62C 3/16; A62C 31/28; B60K 1/00; B60L 50/64; B62D 25/24

(52) U.S. Cl. CPC B60K 1/04; A62C 3/07; A62C 3/16; A62C 31/28; B60L 50/64; B62D 25/24; B60K 2001/005; B60K 2001/0438

(57) ABSTRACT

A safety device for a battery of an electric or hybrid vehicle. The safety device includes a floor portion of the vehicle equipped with a fusible means covering an opening for accessing the battery in order to spray an extinguishing fluid. The safety device also includes a guide member configured to guide the extinguishing fluid towards the battery, the guide member including a mounting plate arranged on a structure of the vehicle around the fusible means, and includes deployable means such that the guide member is configured to move from a position where it is retracted against the floor portion to a position where it is deployed in vicinity of the battery.

### DESCRIPTION

The present invention relates to the field of batteries, notably for electric or hybrid vehicles, and more particularly batteries comprising safety devices that contribute to the function of extinguishing the battery in the event of a vehicle fire.

Electric or hybrid powered vehicles comprise an energy storage battery that supplies power to the electric motor.

These batteries release heat as they operate and their operating temperature is monitored to prevent them from being exposed to extremely high levels of heat at which they may suffer degradation or even ignite. This risk is notably present in the event of the vehicle being involved in an accident that may result in damage to the battery and notably to the electrochemical cells that are housed within a case enclosing the battery. In the event of fire, the very great release of heat in close proximity to the battery may give rise to a thermal runaway phenomenon within the electrochemical cells which may then in turn self-ignite within the battery. Such a fire of chemical origin is very difficult to extinguish, especially if it is contained inside the battery case. There is then the risk of the battery exploding. Furthermore, the electrochemical cells may emit toxic and flammable liquids and/or gases.

In order to prevent these risks of explosion, it is important to inject a large quantity of extinguishing fluid into the battery case as quickly as possible in order to submerge all of the components present inside the battery case.

To that end, it is known practice to provide a safety device that has two distinct technical elements: on the one hand, an opening in the floor which opening is associated with a fusible means that seals the floor under normal conditions of use of the vehicle and is able to yield under appropriate conditions in order to allow the end of a fire hose nozzle, through which the extinguishing fluid is sprayed at high pressure, to pass, and on the other hand a safety relief device formed in a top part of the battery case, which once again is able to yield under appropriate conditions so as to allow the extinguishing fluid sprayed by the fire hose nozzle to enter the battery case.

Advantageously, the safety relief device is positioned in alignment with the fusible means so that almost all of the extinguishing fluid sprayed through the fusible means enters the case through the safety relief device.

The electrification of an increasingly high number of vehicles has led to diversity in the specifications offered by the manufacturers. It is now possible, for a given vehicle, to select the type of battery desired, notably on the basis of financial considerations, considerations regarding the power to be supplied to the electric motor and/or considerations regarding range-autonomy. These different types of battery have different shapes and sizes, which means that the safety relief device formed in the top part of the battery may be situated in different positions on the vehicle in which whatever battery is mounted. As far as they are able, the manufacturers provide a floor in which the fusible means is positioned in alignment with the safety relief device. For various reasons, notably constraints on space availability, this is sometimes not possible.

Moreover, in the context of economy of scale, the platforms, which is to say the structural base of the vehicles, may be common to a number of vehicles which may be equipped with batteries of different sizes. The position of the fusible means on the floor needs to be fixed for all vehicles using this common platform, and the fusible means may thus face the safety relief device for certain types of battery and be offset therefrom in one or more directions for others.

The present invention falls within this context and seeks to propose a safety device for a motor vehicle that allows operations of spraying extinguishing fluid into the interior of each of the different types of battery liable to be fitted to this vehicle to be performed effectively.

The main subject of the present invention is thus a safety device for a battery of an electric or hybrid vehicle, which device comprises a floor portion of the vehicle equipped with a fusible means covering an opening for accessing the battery for spraying and extinguishing fluid, characterized in that it further comprises a guide member configured to guide said extinguishing fluid toward the battery, said guide member comprising both a mounting plate, arranged on a structure of the vehicle around the fusible means, and deployable means such that the guide member is configured to move from a retracted position in which it is retracted against the floor portion to a deployed position in which it is deployed in the vicinity of the battery.

The purpose of the safety device according to the invention is to perform a function of extinguishing the battery should the latter catch fire, by enabling an extinguishing fluid to be guided toward the battery and more particularly inside this battery, water representing one extinguishing fluid.

The deployable, or telescopic, nature of the guide member ensures that the free end of the guide member is in contact with the battery, and more particularly is in the vicinity of a fusible access device of the battery, whatever the position of this battery. The deployed position of the guide member may thus be understood as meaning the position of maximum deployment or a position of intermediate deployment in which the free end of the guide member is in contact with the battery. It is thus possible, for the one same platform with a standard floor and a standard guide member arranged facing this floor, to allow for the arrangement of several types of battery while ensuring that the extinguishing fluid is correctly guided so that it can submerge the battery, without being lost between the floor and the battery.

By way of example, battery types may differ in terms of a number of parameters, such as the electrical power that they can supply or the range autonomy. Thus, for vehicles requiring high power and extended range autonomy, a battery of a first type, of larger dimensions in order to accommodate more electrochemical elements, is housed beneath the floor, the fusible access device being located close to the floor. By contrast, for vehicles requiring a lower power and less range autonomy, a battery of a second type, of smaller dimensions, is housed beneath the floor leaving a greater distance between the fusible access device of this battery and the floor than for batteries of the first type.

As mentioned, the floor of the vehicle comprises a fusible means that constitutes a point of reference for the positioning of the fire hose nozzle when professional firefighters are called upon to intervene. The guide member is able to guide the extinguishing fluid toward the fusible access device of the battery, whatever battery is housed beneath the floor, as the free end of the guide member is able to deploy to a greater or lesser distance from the floor until it comes into contact with the surface of the battery facing the floor.

The deployable nature of the guide member thus has the objective of ensuring, using one single component mounted as standard on the floors of different vehicles, that the battery mounted elsewhere on the vehicle, whatever the type of this battery, is supplied with the greatest possible amount of the extinguishing fluid sprayed by the fire hose nozzle, by adapting the distance of deployment of the guide member according to the dimensions specific to each battery type. A system that is effective in combating battery fires, in a context in which there are multiple different types of battery that can be installed on the vehicles, is thus combined with standardization of the means employed.

According to one optional feature of the invention, the guide member is configured to deploy under the effect of the pressure exerted by the extinguishing fluid.

According to one optional feature of the invention, the guide member is configured to be in a deployed position when it receives the extinguishing fluid.

According to one optional feature of the invention, the floor portion comprises an upper face facing toward a cabin of said vehicle and a lower face facing toward the battery, the guide member being arranged facing the lower face of the floor portion.

According to one optional feature of the invention, the mounting plate of the guide member is attached to the lower face of the floor. This then ensures that the guide member is arranged directly against the lower face of the floor and that the extinguishing fluid is directed in its entirety through the guide member, without losses between the floor and the guide member, thereby optimizing the effectiveness of the system.

Alternatively, in instances where so doing would simplify the factory assembly process for example, provision could be made for the guide member, via its mounting plate, to be attached to other structural elements of the vehicle and, for example, to the crossmembers that form a floor support.

According to one optional feature of the invention, the deployable means comprise a fixed base secured to the mounting plate, the fixed base being dimensioned to surround the access opening covered by the fusible means.

In the event of a battery fire, or risk of fire, the professional firefighters position a fire hose nozzle on the access opening and the extinguishing fluid is sprayed through this opening once the fusible means has yielded. The fact that the fixed base of the deployable means surrounds the access opening ensures that all of the extinguishing fluid sprayed spreads through the guide member until it reaches the burning battery and is able to effectively submerge same.

According to one optional feature of the invention, the guide member comprises a retaining system retaining the deployable means, the retaining system being able to hold the guide member in a retracted position, said retaining system being configured to yield under a determined pressure and/or at a determined temperature.

Under normal situations of use of the vehicle, namely notably when there is no fire with the risk of causing thermal runaway within the battery, the guide member is not called into action and maintains a retracted position such as it has occupied since the moment at which it was assembled onto the structure of the vehicle. This retracted position thus forms a base position of the guide member. When the high-pressure extinguishing fluid is sprayed onto the guide member, or when said member is subjected to an excessive temperature indicative of the outbreak of fire, the retaining system yields and the deployable means can adopt a deployed position in order to form a conduit to guide the extinguishing fluid.

According to one optional feature of the invention, the deployable means comprise a plurality of ring sections arranged successively one inside the other and able to slide pairwise one inside the other as the guide member moves from the retracted position to the deployed position. In other words, the deployable means are nested means in the form of ring sections, that are substantially concentric when the guide member is in the retracted position. Further, a ring section of the deployable means is made to slide, as the guide member deploys, inside the directly adjacent ring section that surrounds it and with it forms a pair of ring sections.

According to one optional feature of the invention, the fixed base of the deployable means is formed by the largest-sized ring section inside which each of the other ring sections are successively housed.

According to one optional feature of the invention, the ring sections comprise angular-indexing means configured to enable angular positioning of the ring sections relative to one another in the retracted position.

According to one optional feature of the invention, the ring sections extend around a main axis of elongation, said deployable means comprising deviation means borne by at least one of the ring sections and configured to guide the movement of one ring section with respect to the ring section surrounding it in a direction that is inclined with respect to the main axis of elongation of this ring section that surrounds it.

These deviation means enable a curved profile to be imposed gradually on the deployment of the guide member, thus directing the free end of the guide member toward a battery safety relief device when this safety relief device is not in alignment with the access opening in the floor and with the associated fusible means.

According to one optional feature of the invention, at least one ring section comprises, at its free-end edge, facing away from the floor portion, a geometry that is chamfered to make it easier for the ring section that it surrounds to deviate in said inclined direction.

According to one optional feature of the invention, at least one ring section has a stop means configured to limit the movement of this ring section with respect to the ring section that surrounds it.

In other words, the at least one ring section comprises a turned-up edge capable of coming into abutment against a turned-up edge of the ring section surrounding it, the at least one ring section being able to slide as far as this end-of-trap stop once the guide member retaining system has yielded.

In a variant, each ring section may be held by a system of chains arranged respectively between this ring section and the ring section that surrounds it, each chain being dimensioned so that the ring section that moves within the ring section that surrounds it does not move beyond a free end edge of the ring section that surrounds it.

According to one optional feature of the invention, the guide member may be made of fiber-reinforced plastic.

The fibers are notably selected for their thermal properties, to allow the guide member to withstand high temperatures associated with fires and potentially with the runaway of the electrochemical means present inside the battery case. Alternatively, the guide member could be made of steel, which offers the advantage of having good fire resistance capabilities. In order to alleviate the potential disadvantage of a greater weight to be considered in the overall weight of the vehicle, a guide member made of steel is configured using thin sheet metal.

According to one optional feature of the invention, the fusible means present in the floor and able to provide access to the battery is able to melt under the action of heat and is configured to yield if the temperature exceeds a given temperature threshold and/or to yield in the event of overpressure exerted by means for pressurized spraying of the extinguishing fluid.

The invention also relates to an electric or hybrid motor vehicle, comprising a battery arranged beneath a floor and a safety device as mentioned hereinabove, said battery having an upper face facing the floor and comprising a fusible means covering an access opening, characterized in that the deployable means of the guide member are configured to give the guide member a deployed position that faces the fusible device of the battery.

In the retracted position, the guide member is advantageously withdrawn between structural elements bearing the floor, notably crossmembers, so as to protect the guide member.

As has been mentioned, thanks to the presence of the deployable, or telescopic, guide member, it is possible to ensure that the free end of this guide member is always in the vicinity of, advantageously in contact with, the top surface of the battery and therefore the fusible access device, or safety relief device, whatever the type of battery present beneath the floor, namely whatever the size and shape of the battery, and more particularly whatever the position of the safety relief device that forms the fusible access device with respect to the floor and the fusible means on which the fire hose nozzle will be positioned.

The invention also relates to a method for improving the safety of a battery fitted to a motor vehicle as mentioned hereinabove, wherein an extinguishing fluid is sprayed toward the battery when the battery is in an at-risk situation, said fluid being sprayed through the access opening present in the floor once the fusible means has yielded, and wherein the guide member is configured into a deployed position so as to position it facing an appropriate zone of the battery under the force of the spray of extinguishing fluid exiting a fire hose nozzle.

Further features, details and advantages of the invention will become more clearly apparent from reading the following description, of a detailed embodiment, given by way of nonlimiting indication, with reference to the appended drawings, in which:

FIG. 1 is a partial illustration, in perspective, of an electric or hybrid vehicle equipped with a battery of a first type and with a safety device according to one aspect of the invention, with a floor in which a battery access opening is formed, which opening is here closed by a fusible means and a guide member for guiding an extinguishing fluid, for example a jet from a fire hose nozzle, toward a safety relief device formed at the top of the battery;

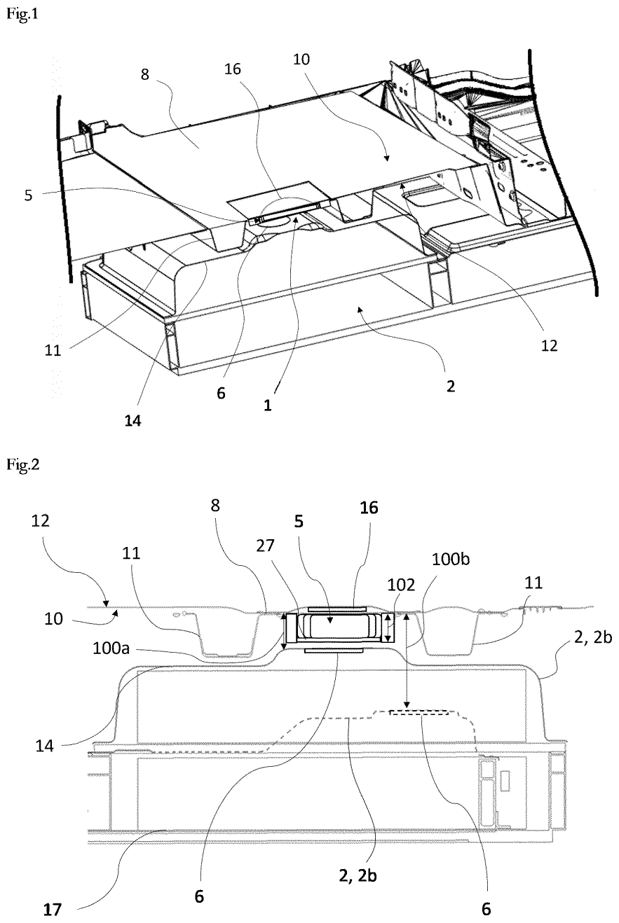

FIG. 2 schematically illustrates, in section, the safety device of FIG. 1 with the guide member in a retracted position, this figure showing two different types of battery that can be associated with the operation of the safety device, with the first type of battery from FIG. 1 depicted in solid line and a second type of battery depicted in broken line;

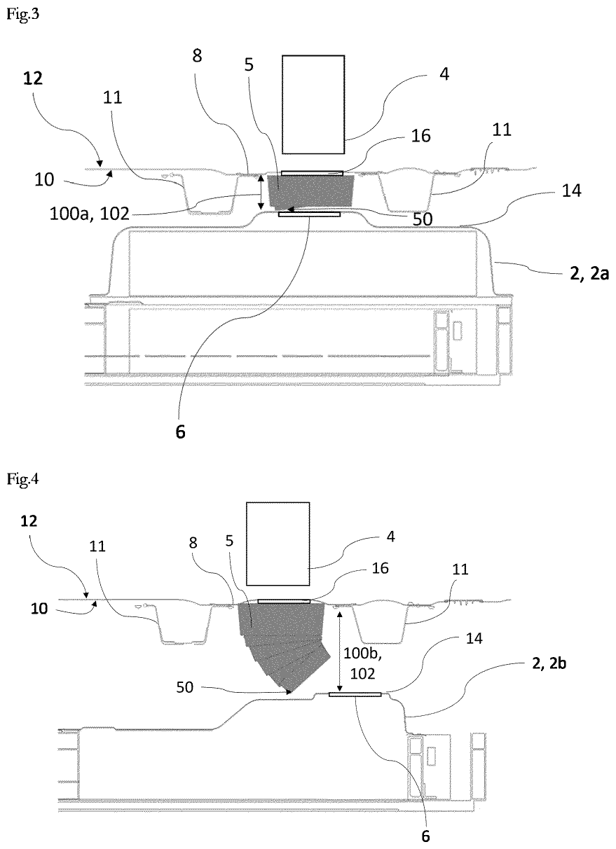

FIG. 3 schematically illustrates, in section, the safety device of FIG. 2 with the guide member this time in a deployed position when the safety device is associated with the first type of battery;

FIG. 4 schematically illustrates, in section, the safety device of FIG. 2 with the guide member this time in a deployed position when the safety device is associated with the second type of battery;

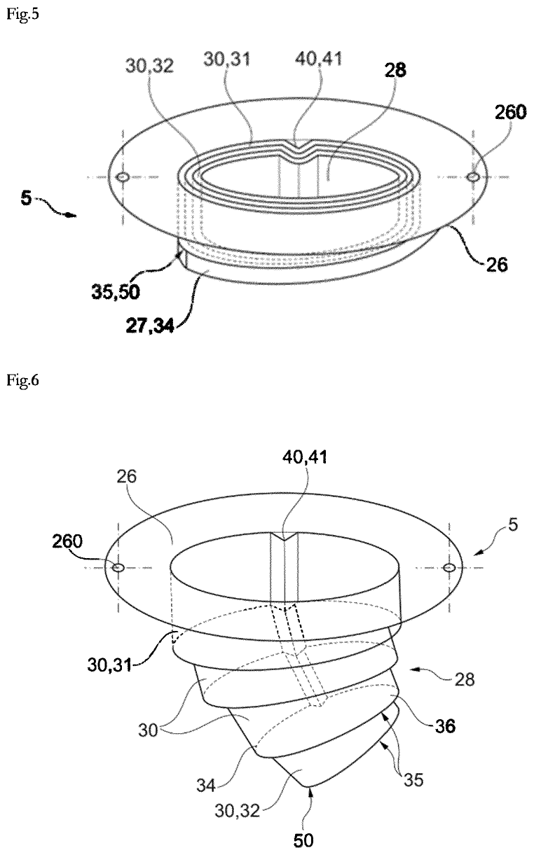

FIG. 5 schematically illustrates one embodiment of the deployable guide member illustrated in the preceding figures, here in the retracted position;

FIG. 6 schematically illustrates the deployable guide member of FIG. 5, in the deployed position visible in FIG. 4;

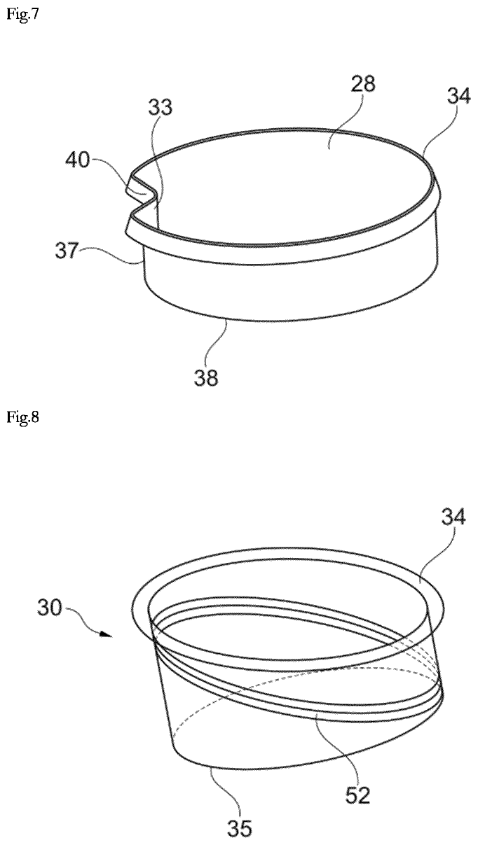

FIG. 7 schematically illustrates one of the components of the guide member of FIGS. 5 and 6; and

FIG. 8 schematically illustrates a variant embodiment of a component that forms a deployable guide member.

The features, variants and various embodiments of the invention, as have been described or as will be set out in the detailed description that is to follow, may be combined with one another, in various combinations, as long as they are not mutually incompatible or mutually exclusive. It will be possible, in particular, to imagine variants of the invention that comprise only a selection of features described below, in isolation from the other features described, if this selection of features is sufficient to provide a technical advantage and/or to differentiate the invention from the prior art.

Remember that the invention proposes a safety device 1 intended to equip a vehicle, notably an electric or hybrid powered vehicle, enabling, in the event of a battery 2 incorporated into said vehicle catching fire, a guide member 5 to be deployed under the effect of the force exerted by the jet of an extinguishing fluid from a fire hose nozzle 4, the deployment of the guide member seeking to guide the extinguishing fluid appropriately onto the burning battery in order to submerge it as effectively as possible. In that context, the invention more particularly proposes a guide member able to adopt deployed positions suitable for effectively guiding the extinguishing fluid onto several types of battery with which the vehicle on which the safety device is mounted is likely to be equipped.

In the description that follows, the term battery will be used to notably cover the notion of battery pack, namely a case inside which are arranged electrical energy storage cells and a plurality of electronic components that helped to manage the charging and discharging of these cells, and regardless of the shape of the cells.

FIGS. 1 and 2 thus illustrate part of the vehicle equipped with a safety device according to the invention, with a guide member 5 in a retracted position.

The vehicle comprises a floor 8 which is arranged between the cabin and the underbody structure of the vehicle, resting on various structural elements of the vehicle including in this instance two crossmembers 11 extending transversely to the main longitudinal direction of the vehicle.

The floor 8 comprises a lower face 10 and an upper face 12, the upper face 12 facing the cabin of the vehicle and the lower face facing the underbody structure of the vehicle.

The floor 8 comprises a fusible means 16 arranged in the thickness of the floor portion and which covers an access opening passing through the floor 8 from the upper face 12 to the lower face 10. The access opening, once the fusible means has yielded, allows the position of the fire hose nozzle 4 to be indexed so that the jet of extinguishing fluid sprayed by the fire hose nozzle 4 can be directed towards the underbody structure and toward the battery 2.

The lower face 10 of the floor 8 faces the battery 2 and notably faces a top surface 14 of the battery 2. This top surface 14 comprises a fusible access device, in this instance a safety relief device 6, that covers a zone providing access to the inside of the battery. It will be appreciated that when a fire breaks out in the battery or the battery is on fire, anybody intervening with a view to making the vehicle safe can aim to spray a maximum quantity of extinguishing fluid through this safety relief device 6 so that the extinguishing fluid, notably the jet of water, coming from the fire hose nozzle 4 can spread within the interior of the battery and as far as a bottom wall of the battery 17 in order to submerge the flames.

The guide member 5 previously mentioned has the purpose of guiding the jet of extinguishing fluid more precisely. For this purpose it is arranged between the battery 2 and a floor portion 8, in this instance between the crossmembers 11, surrounding the fusible means 16.

As visible in FIG. 2, a clearance distance 100 is defined for each type of battery liable to be fitted to the vehicle equipped with the safety device, this clearance distance 100 being measured between the lower face 10 of the floor and that part of the top surface 14 that comprises the safety relief device 6. The guide member 5 of the safety device 1 can deploy in such a way that its free end 50 is able to come to face the safety relief device 6 of the top surface whatever the clearance distance 100. In other words, the guide member is configured to extend, in the event of a fire or accident and of an operation of spraying an extinguishing fluid toward the battery, between the floor 8 and the top surface 14 of the battery 2, regardless of the type of battery 2 mounted on the vehicle equipped with the safety device, as is notably visible in, respectively, FIG. 3 for a first type of battery 2a and FIG. 4 for a second type of battery 2b.

Two types of battery are depicted in FIG. 2, but it should be noted that their respective shapes and sizes, and notably the position of their safety relief device 6 with respect to the fusible means 16 of the floor, are depicted here by way of example to illustrate the fact that the guide member 5 is configured to adopt a number of deployed positions, and that other types of battery could be fitted to the vehicle with the same advantages of use of the safety device according to the invention, namely of providing a standard means that is able to effectively guide the extinguishing fluid for several types of battery. In the example illustrated in FIG. 2, the battery 2 may be of a first type 2a or of a second type 2b, the first type of battery 2a corresponding to a battery with dimensions larger than those of the second type of battery 2b. Depending on the options desired by those acquiring these vehicles, it is desirable to be able to employ, beneath the floor, a battery offering greater range autonomously, something that is provided for by the larger dimensions of the battery of the first type 2a, or else a less-expensive battery, like the battery of the second type 2b.

FIG. 2 schematically illustrates the context of the incorporation of two different types of battery into the structure of a standard vehicle, which remains the same overall regardless of the type of battery incorporated. The battery of the second type 2b, indicated in broken line, is smaller than the battery of the first type which means that its aforementioned clearance distance 100b is greater than the clearance distance 100a associated with a battery of the first type 2a. Moreover, the safety relief device 6 present in the top surface 14 of the battery of the second type 2b is longitudinally offset in relation to the fusible means 16 formed in the floor portion 8 arranged in alignment with the battery.

The guide member 5 will now be described in greater detail, with reference to FIG. 2 when describing its retracted position, and with reference to FIG. 3 when describing a deployed position when associated with a battery of the first type 2a, and to FIG. 4 when describing a deployed position when associated with a battery of the second type 2b.

The guide member 5 comprises a mounting plate 26 and deployable means 28 that form a conduit for guiding the extinguishing fluid and of which the deployment with respect to the mounting plate defines the elongation of the guide member.

The mounting plate 26 is configured to enable the guide member 5 to be attached to the vehicle structure, and more particularly here to the lower face 10 of the floor 8. The mounting plate 26 is arranged around the opening formed in the floor and covered by the fusible means 16, so that the conduit formed by the deployable means faces this opening.

The guide member comprises a retaining system 27 depicted schematically in FIG. 2 and which allows the guide member to be held in its retracted position under normal conditions of use of the vehicle when no battery fire or risk of battery fire has been identified.

It is notable that the guide member 5, in its retracted position, is not in contact with the top surface 14 of the battery irrespective of the type of battery with which the vehicle is equipped, this clearance space making it easier to mount the battery in the vehicle and avoiding noise caused by the vibrating of the components when the vehicle is running.

The retaining system 27 may be produced in various ways without departing from the context of the invention, provided that it enables the guide member to be held in its retracted position when the vehicle is under normal conditions of use and that it becomes inoperational, so as to allow the guide member to adopt its deployed position, as soon as an increase in temperature indicative of the outbreak of fire occurs or as soon as an extinguishing fluid is sprayed through the opening in the floor. By way of example, the retaining system may be a heat-meltable device arranged to cross the direction of movement of the deployable means of the guide member, or else may be a ring with frangible portions that are dimensioned to yield under the pressure of an extinguishing fluid sprayed by a fire hose nozzle.

In the embodiment the detailed description of which follows, with components of the deployable means that move relative to one another to form a telescopic device, the retaining system 27 may also consist in the components being dimensioned relative to one another in such a way as to achieve a tight fit that prevents movement under normal conditions of normal use but does not prevent movements under the effect of a pressure exerted by the extinguishing fluid sprayed by a fire hose nozzle.

When such a pressure is exerted, or else when an excessive temperature indicative of the outbreak of fire is reached, the retaining system becomes inoperational and the guide member 5 deploys until it adopts its configuration of maximum elongation or until it comes into abutment with the top surface 14 of the battery 2 with which the vehicle is equipped.

An elongation distance 102 of the guide member 5 is determined as being a vertical distance, substantially perpendicular to the floor 8 facing which the guide member is arranged, between the mounting plate 26 and the free end 50 of the guide member, which is at the opposite end from the mounting plate 26. The deployable means 28 of the guide member 5 are configured to be able to exhibit a maximum elongation distance at least equal to the largest clearance distance that may be attained with one of the types of battery with which the vehicle is liable to be equipped.

In the example of FIG. 3, with a battery of the first type 2a which generates a clearance distance 100a which is less than this maximum clearance distance 102, the deployable means 28 do not deploy in full and the deployed position of the guide member is reached when the free end 50 of the guide member 5 comes into contact with the top surface of the battery of the first type 2a.

In the example of FIG. 4, with a battery of the second type 2b which generates a clearance distance 100b which is at least equal to this maximum clearance distance 102, the deployable means 28 deploy in full and the deployed position of the guide member is reached with the free end 50 of the guide member either in contact with the top surface of the battery of the second type 2b or in the immediate vicinity thereof.

In the example of FIG. 4, and as mentioned previously, the battery of the second type 2b has a safety relief device 6 that is offset longitudinally in relation to the opening formed in the panel and the associated fusible means 16. The deployed position of the guide member is such that the deployable means 28 extend with an inclination with respect to a direction normal to the floor. Appropriate deviation means are provided within the guide member in order to impart a curved shape to it as it deploys. Of course, if all the batteries intended to equip the vehicle are configured in such a way that their safety relief device 6 is arranged in alignment with the fusible means 16, the guide member 5 does not comprise such deviation means and the deployable means deploy in a direction perpendicular or near-perpendicular to the floor.

In this context of deployable means equipped with deviation means for giving the guide member a deployed position that is inclined, it is notable that the deployed position of the guide member 5 when a battery of the first type 2a is fitted to the vehicle remains near-perpendicular to the floor because of the short deployment distance needed in order to come into contact with the top surface 14 of the battery 2.

The guide member will now be described in greater detail with reference to an embodiment illustrated in FIGS. 5 to 7, it being understood that the general features specified hereinabove may apply to other embodiments.

As already mentioned, the guide member comprises a mounting plate 26 which is configured to enable attachment to a structural element of the vehicle and notably to the lower face 10 of a floor portion 8. In the example illustrated, the mounting plate comprises holes 260 through which suitable assembly means, notably fixing screws, can pass. The mounting plate may be secured to the structure of the vehicle by other means, for example by welding, notably given that the guide member 5 is a standard component with which the vehicle is equipped irrespective of the type of battery employed.

The deployable means 28 of the guide member 5, which form a conduit able to guide the extinguishing fluid, comprise a plurality of ring sections 30 arranged successively one inside the other, in an arrangement that is concentric when the guide member is in its retracted position. When considering the radial dimension of the ring sections 30, in this instance the diameter about a main axis of elongation substantially perpendicular to the floor, it is possible to identify an initial ring section 31, of greatest radial dimension, that surrounds all the others, a final ring section 32 of smallest radial dimension that is surrounded by all the others and, as applicable, one or more intermediate ring sections the corresponding radial dimensions of which become increasingly smaller toward the final ring section.

The initial ring section forms a fixed base 31 of the guide member, secured to the mounting plate. The height, which is to say the axial dimension along the main axis of elongation of the ring sections, of this fixed base 31 is at least equal to and, where applicable, greater than, the height of the other ring sections so that in the retracted position none of the other ring sections protrudes beyond the fixed base.

The retaining system 27 mentioned previously is, in the example illustrated, formed by a membrane 34 arranged at the free end edge 35 of the fixed base 31, across the passage section defined by the initial ring section that forms this fixed base. The membrane is dimensioned to withstand the pressure exerted by the ring sections under the effect of gravity, but to yield when there is an extinguishing-fluid pressure or a temperature equivalent to that which occurs in a fire. It should be noted that the thickness of the membrane may have been exaggerated in FIG. 5 in order to make it visible and make its position clearer.

When the retaining system 27 yields, each ring section 30 is able to slide inside the ring section that surrounds it, under the effect of gravity and where applicable of the pressure of the extinguishing fluid, the guide member then moving from the retracted position to the deployed position.

The sliding of the ring sections comes to an end either because the free end edge of one of the ring sections, notably the free end edge 35 of the final ring section 32, comes into contact with the battery 2, or because the deployable means 28 have been elongated to the maximum extent. In that case, each of the ring sections able to move inside the initial ring section that forms the fixed base 31 is in an end-of-travel butting position.

Stop means are thus provided to limit the deployment of each ring section 30 inside the ring section that surrounds it and to ensure that each ring section remains engaged with the other ring sections and contributes to forming a conduit for guiding the extinguishing fluid. In the embodiment illustrated, each mobile ring section thus comprises a turned-up edge 34, as visible in FIG. 7, that forms a radial projection, toward the outside of the ring section, at an end edge facing toward the floor portion 8, and which is intended to come into contact with a turned-up edge 38 present on the ring section that surrounds it and that forms a radial projection toward the inside of this ring section.

Each ring section also comprises angular-indexing means aimed at ensuring correct positioning of the ring section within the ring section that surrounds it and notably aimed at allowing angular positioning of the ring sections relative to one another in the retracted position. In the embodiment illustrated, each mobile ring section comprises a local deformation 40 that reduces the passage cross section of the conduit in this ring section. It is the complementing nature of the shapes of these local deformations that allows a ring section to be inserted between another ring section of greater radial dimension.

Moreover, in so far as at least one of the types of battery has a safety relief device 6 that is offset longitudinally relative to the fusible means 16 and the guide member needs to be given an inclined shape as it deploys, as mentioned previously, at least one of the ring sections may comprise deviation means for guiding the movement of a ring section with respect to the ring section that surrounds it in a direction that is inclined with respect to the main axis of elongation of this ring section that surrounds it.

In the embodiment illustrated, these deviation means are formed in part by the aforementioned local deformation 40, in so far as this has a slope that is inclined with respect to the main axis of elongation. The ring section that slides along the local deformation 40 formed in the ring section that surrounds it is made to move in a direction of travel that is inclined with respect to the main axis of elongation of the ring section that surrounds it. By incremental progression, the final ring section 32 has a main axis of elongation that is inclined in multiple steps with respect to the main axis of elongation of the initial ring section 31. Moreover, in order to allow the ring section that it surrounds to slide in an inclined direction, at least the initial ring section and the intermediate ring sections have a chamfered shape at their free end edge 35. The chamfer is produced in such a way that the axial dimension of the ring section is reduced on the opposite side to the local deformation.

Of course, there are alternative ways of obtaining deployable means equivalent to what has just been described and capable of generating a telescopic effect enabling the free end 50 of the guide member 5 to be positioned as close as possible to the safety relief device 6 formed in the top surface 14 of the battery.

By way of nonlimiting example, FIG. 8 illustrates a variant embodiment of a ring section forming the deployable means. In this variant, the ring section has, on its external surface, a helicoidal groove 52 able to guide the movement of one ring section inside the ring section that surrounds it. The helical groove here replaces the local deformation to form angular-indexing means. As an equivalent to that which was described hereinabove, travel end-stop means are provided and here formed by a turned-over edge 34. The deviation means as before comprise a chamfered end edge of the ring section and the ramp forming an inclined plane for the guidance of the ring section in a direction that is inclined with respect to the axis of elongation may be formed by a local additional thickness, not depicted here.

The outcome of the foregoing is that the invention has indeed achieved its stated objectives, namely that of proposing a system that provides effective guidance of the extinguishing fluid sprayed by a fire hose nozzle upon intervention on a vehicle that has been involved in an accident so as to direct it onto a precise location of the battery, regardless of the type of battery with which the vehicle is equipped, in a context of standardization of the assembly platforms meaning that several types of battery may be mounted on the one same vehicle structure.

The guide member that chiefly forms the subject matter of the invention may maintain a retracted position until such time as the use of the fire hose nozzle commences, which is to say until such time as the fire hose nozzle is positioned facing the fusible means present on the floor portion. The deployed position of the guide member is obtained by virtue of the pressure exerted by the extinguishing fluid sprayed by the fire hose nozzle, which has the effect of rendering inoperative the retaining system associated with the deployable means of the guide member.

Alternatively, the guide member that chiefly forms the subject matter of the invention may adopt its deployed position prior to the use of the fire hose nozzle, as soon as the retaining system is rendered inoperative for example by an excessive temperature or by extraordinary jolts that occur when the vehicle suffers a violent impact.

Of course, the invention is not restricted to the examples that have just been described, and numerous reconfigurations may be made to these examples without departing from the scope of the invention, provided that a deployable structure is able to guide an extinguishing fluid between the floor and the battery, notably in order to adapt to suit whatever type of battery is fitted to the vehicle.

1. A safety device for a battery of an electric or hybrid vehicle, the device comprising:
a floor portion of the vehicle equipped with a fusible means covering an opening for accessing the battery for spraying an extinguishing fluid; and
a guide member configured to guide said extinguishing fluid toward the battery, said guide member comprising both a mounting plate, arranged on a structure of the vehicle around the fusible means, and deployable means such that the guide member is configured to move from a retracted position in which it is retracted against the floor portion to a deployed position in which it is deployed in vicinity of the battery.

2. The safety device as claimed in claim 1, wherein the floor portion comprises an upper face facing toward a cabin of said vehicle and a lower face facing toward the battery, the guide member being arranged facing the lower face of the floor portion.

3. The safety device as claimed in claim 2, wherein the mounting plate of the guide member is attached to the lower face of the floor.

4. The safety device as claimed in claim 1, wherein the deployable means comprise a fixed base secured to the mounting plate, the fixed base being dimensioned to surround the access opening covered by the fusible means.

5. The safety device as claimed in claim 1, wherein the guide member comprises a retaining system retaining the deployable means, the retaining system being able to hold the guide member in a retracted position, said retaining system being configured to yield under a determined pressure and/or at a determined temperature.

6. The safety device as claimed in claim 5, wherein the deployable means comprise a plurality of ring sections arranged successively one inside the other and able to slide pairwise one inside the other as the guide member moves from the retracted position to the deployed position.

7. The safety device as claimed in claim 6, wherein the ring sections comprise angular-indexing means configured to enable angular positioning of the ring sections relative to one another in the retracted position.

8. The safety device as claimed in claim 6, wherein the ring sections extend around a main axis of elongation, said deployable means comprising deviation means borne by at least one of the ring sections and configured to guide movement of one ring section with respect to the ring section surrounding it in a direction that is inclined with respect to the main axis of elongation of this ring section that surrounds it.

9. The safety device as claimed in claim 6, wherein at least one ring section has a stop means configured to limit the movement of this ring section with respect to the ring section that surrounds it.

10. An electric or hybrid motor vehicle, comprising:
a battery arranged beneath a floor; and
the safety device as claimed in claim 1, said battery having an upper face facing the floor and comprising a fusible access device, wherein
the deployable means of the guide member are configured to give the guide member a deployed position that faces the fusible device of the battery.

11. A method for improving the safety of a battery fitted to a motor vehicle as claimed in claim 10, wherein an extinguishing fluid is sprayed toward the battery when the battery is in an at-risk situation, said fluid being sprayed through the access opening present in the floor once the fusible means has yielded, and wherein the guide member is configured into a deployed position so as to position it facing an appropriate zone of the battery under force of the spray of extinguishing fluid exiting a fire hose nozzle.

12. The safety device as claimed in claim 2, wherein the deployable means comprise a fixed base secured to the mounting plate, the fixed base being dimensioned to surround the access opening covered by the fusible means.

13. The safety device as claimed in claim 3, wherein the deployable means comprise a fixed base secured to the mounting plate, the fixed base being dimensioned to surround the access opening covered by the fusible means.

14. The safety device as claimed claim 2, wherein the guide member comprises a retaining system retaining the deployable means, the retaining system being able to hold the guide member in a retracted position, said retaining system being configured to yield under a determined pressure and/or at a determined temperature.

15. The safety device as claimed claim 3, wherein the guide member comprises a retaining system retaining the deployable means, the retaining system being able to hold the guide member in a retracted position, said retaining system being configured to yield under a determined pressure and/or at a determined temperature.

16. The safety device as claimed claim 4, wherein the guide member comprises a retaining system retaining the deployable means, the retaining system being able to hold the guide member in a retracted position, said retaining system being configured to yield under a determined pressure and/or at a determined temperature.

17. The safety device as claimed in claim 7, wherein the ring sections extend around a main axis of elongation, said deployable means comprising deviation means borne by at least one of the ring sections and configured to guide movement of one ring section with respect to the ring section surrounding it in a direction that is inclined with respect to the main axis of elongation of this ring section that surrounds it.

18. The safety device as claimed in claim 7, wherein at least one ring section has a stop means configured to limit the movement of this ring section with respect to the ring section that surrounds it.

19. The safety device as claimed in claim 8, wherein at least one ring section has a stop means configured to limit the movement of this ring section with respect to the ring section that surrounds it.

20. The electric or hybrid motor vehicle as claimed in claim 10, wherein the floor portion comprises an upper face facing toward a cabin of said vehicle and a lower face facing toward the battery, the guide member being arranged facing the lower face of the floor portion.
